(19) United States
(12) Patent Application Publication
(10) Pub. No.: US 2015/0334014 A1
(43) Pub. Date: Nov. 19, 2015

(54) IP ADDRESS BASED UDP RELAY

(71) Applicant: ALCATEL LUCENT, Paris (FR)

(72) Inventors: Sanjeeva Reddy YERRAPUREDDY, Murray Hill, NJ (US); Srivatsa KEDILAYA, Bangalore (IN); Lathakannan ARUMUGAM, Murray Hill, NJ (US)

(73) Assignee: ALCATEL LUCENT, Paris (FR)

(21) Appl. No.: 14/651,179

(22) PCT Filed: Oct. 31, 2013
(86) PCT No.: PCT/EP2013/003280

§ 371 Date: Jun. 10, 2015

(30) Foreign Application Priority Data
Dec. 31, 2012 (IN) 4075/DEL/2012

(51) Int. Cl. H04L 12/741; H04L 29/06; H04L 29/12

(52) U.S. Cl. CPC H04L 45/74; H04L 61/2007; H04L 61/106; H04L 69/164

(57) ABSTRACT

The present subject matter discloses a method for UDP relay in communication networks. In one implementation, a UDP port number included in a header of a message is identified. The method further includes ascertaining the IP address based on a mapping table, where the mapping table includes a list of plurality of UDP port numbers mapping to the IP addresses of corresponding destination servers. Further, the message is modified to obtain a modified message based at least on the IP address. Subsequently, the modified message is unicasted to the destination IP address.

### FIELD OF INVENTION

The present subject matter relates to communication systems and, particularly but not exclusively, to communication systems utilizing IP address based UDP relay.

### BACKGROUND

In communication networks utilizing Internet Protocol (IP), real-time data, such as audio and/or video (AN) data, is typically transmitted using User Datagram Protocol (UDP). In UDP communication, a communication device, say a transmitting device, intends to transmit some data to a server in the same network, say a virtual local area connection (VLAN), or a different network. In a case, the transmitting device is not aware of the IP address of the server, the transmitting device broadcasts the data, as a message, into the same network. The message thus broadcasted is received by all the communication devices in the same network as the transmitting device and retained by a communication device that is acting as the server for the same network and discarded by other communication devices. The server may subsequently send a response message to the transmitting device to initiate a communication path.

Further, in case the server is not present in the same network, then a UDP relay connected to the same network may broadcast the message to another network or another UDP relay that may in turn broadcast the message to other networks until the message is broadcasted in a network to which the server is connected. However, the UDP relay mechanism of broadcasting the messages usually results in flooding and cluttering of the messages in intermediate network segments in the path to the server, thus congesting the network. Further, employing multiple UDP relays for broadcasting the message may result in increase in cost.

### SUMMARY

This summary is provided to introduce the concept of IP address based UDP relay in communication networks. This summary is not intended to identify essential features of the claimed subject matter nor is it intended for use in determining or limiting the scope of the claimed subject matter.

In one implementation, a method for UDP relay in communication networks is described. The method comprises, identifying a UDP port number included in a header of a message. Further, the IP address is ascertained based on a mapping table, wherein the mapping table includes a list of plurality of UDP port numbers mapping to the IP addresses of corresponding destination servers. Further, the message is modified to obtain a modified message based at least on the IP address. Subsequently, the modified message is unicasted to the destination IP address.

In another implementation, a UDP relay for IP address based UDP relay in communication networks is described. The UDP relay includes a processor and an interaction module coupled to the processor. The interaction module is configured to receive a message from a communication device. Further, the UDP relay includes a processing module coupled to the processor, where the processing module is configured to identify a UDP port number included in a header of the message. The processing module ascertains the IP address based on a mapping table, wherein the mapping table includes a list of plurality of UDP port numbers mapping to the IP addresses of corresponding destination servers, and modifies the message to obtain a modified message based at least on the destination IP address. The UDP relay also includes a network module coupled to the processor. The network module is configured to unicast the modified message to the destination server.

In accordance with another implementation of the present subject matter, a computer-readable medium having embodied thereon, a computer program for executing a method for UDP relay in communication networks is disclosed. The method comprises identifying a UDP port number included in a header of a message. The UDP port number is mapped to the IP address of a destination server or an agent in another network in this method. The method includes ascertaining the IP address based on a mapping table, wherein the table includes a list of plurality of UDP ports and corresponding IP addresses. Further, the message is modified to obtain a modified message based at least on the destination IP address. Subsequently, the modified message is unicasted to the destination IP address.

### BRIEF DESCRIPTION OF THE FIGURES

The detailed description is described with reference to the accompanying figures. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates an exemplary network environment implementation for IP address based UDP relay in communication networks, according to an embodiment of the present subject matter; and

FIG. 2 illustrates a method for IP address based UDP relay in communication networks, in accordance with an embodiment of the present subject matter.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

### DESCRIPTION OF EMBODIMENTS

Systems and methods for IP address based UDP relay are described. The systems and the methods can be implemented in a variety of computing devices communicating through various networks. The communication devices that can implement the described method(s) and systems include, but are not limited to, computing devices, such as a laptop, a desktop computer, a notebook, a mobile phone, a personal digital assistant, cellular phones, smart phones, a workstation, a mainframe computer, a set top box, a media player, central directory servers, database server, file server, print server, web server, application server, and the like. The communication networks in which the described method(s) can be implemented include, but are not limited to, any network using Internet Protocol (IP), Multi Protocol Label Switching (MPLS) networks, Asynchronous Transfer Mode (ATM) networks, Code Division Multiple Access (CDMA) implementing Evolution-Data Optimized or Evolution-Data Only (EVDO), Global System for Mobile Communication (GSM), Universal Mobile Telecommunications System (UMTS), Wideband Code Division Multiple Access (W-CDMA) backhaul networks, and the like. Although the description herein is with reference to personal computers communicating with each other, the methods and the systems may be implemented in other servers and computing systems communicating over a network, as will be understood by a person skilled in the art.

In conventional communication networks utilizing User Datagram Protocol (UDP) for data communication, communication devices interact with each other by way of unicast, multicast or broadcast messages. In one case, a communication device, i.e., a transmitting device, intending to communicate with an intended receiver initially broadcasts a discovery message in the communication network to identify the intended receiver. In one implementation, the intended receiver may be a server for a particular UDP service, identified by a UDP port. The discovery message is subsequently received and processed by all the communication devices connected to the communication network and discarded by the communication devices that are not the intended receiver. While the intended receiver, say a UDP server sends a response message to the transmitting device thus initiating communication with the transmitting device. Thus, broadcasting the discovery message for initiating the communication helps in cases where the transmitting device is not aware of the IP address of the intended receiver. However, broadcasting the discovery messages usually results in flooding and cluttering of the discovery messages in the networks to which the transmitting device and the intended receiver are connected, thus congesting the network.

Further, in other conventional techniques employed in communication environments, such as commercial complexes and offices, where different floors or buildings are occupied by different establishments, separate networks, say, VLANs are typically set up for each floor or building. Thus, data packets broadcasted by a communication device on a floor, say a first floor, are broadcasted in the same floor only, thereby maintaining security. Further, servers for each of the networks are typically set up on a common floor having a server room, say a tenth floor. Subsequently, the data packets have to be broadcasted from one floor to another floor to reach a server corresponding to the floor of the communication device through one or more UDP relays. For instance, data packets from a first floor that need to be sent to the tenth floor are initially broadcasted in the first floor and from there are broadcasted by the UDP relay in each floor, till they reach the UDP relay on the tenth floor, which is in the same network as the intended server. Such a conventional technique however, usually results in congestion of all the intermediate networks corresponding to each of the floors. Alternatively, individual servers may be set up on each floor to avoid congestion of the network on at least one floor. However, setting up separate servers or UDP relays may lead to increase in cost of setting up the communication networks.

According to an implementation of the present subject matter, systems and methods for communication networks utilizing IP address based UDP relay are described. As described before, the systems and the methods can be implemented in a variety of processing and communicating devices capable of communicating with a network according to various different standards defined for the communication. Further, the systems and the methods described herein may be connected through either wired networks or wireless networks provided via different means.

In one embodiment, all networks, say, VLANs present in a communication environment are provided with a UDP relay configured to relay data packets originating in a home network, i.e., a network to which the UDP relay is connected, to a destination server, such as a UDP server, belonging to a destination network, i.e., a network to which the data packets needs to be relayed to. In one implementation, the UDP relay is configured to process the data packets to be broadcasted, hereinafter referred to as the message, to identify the destination server and obtain a modified message. Subsequently, the UDP relay unicasts the modified message to the destination server. For the purpose, the destination server is assigned an IP address. The UDP relay identifies the IP address of the destination server and unicasts the modified message with the IP address as header. Unicast transmission of the modified message based on the IP address of the destination server thus prevents flooding of the message in intermediate networks and destination networks, thus reducing network congestion and costs.

In operation, a communication device, i.e., a transmitting device, intending to send the message to the destination server, initially broadcasts the message in the associated home network. The message is thus received and processed by all communication devices connected to the home network and discarded by the communication devices that are not intended receiver of the message. In case the destination server is connected to the home network, the destination server responds to the broadcast message, otherwise, the UDP relay connected to the home network processes the broadcast message for transmitting it further.

For the purpose, the UDP relay initially identifies the IP address of the destination server of the destination network, for example, based on a UDP port number provided in the message. In one implementation, a user, for example, a network administrator configures the IP address of the destination server and maps the IP address to the respective UDP port number, such that the IP address associated with the destination server may be identified based on the UDP port number. The transmitting device, while broadcasting the message may provide the UDP port number in the message that may be ascertained by the UDP relay upon processing of the message. Upon ascertaining the UDP port number, the UDP relay may identify the IP address of the destination server, for example, by using a mapping table listing the UDP port number mapped to the IP address of the destination server. For example, the communication device intending to transmit a message to a destination server of a destination network having an IP address 192.168.58.21 and UDP port number as 5001 may add the UDP port number in the message and broadcast the message in the home network. The UDP relay on receiving the message may process the same and ascertain the UDP port number as 5001. Based on the UDP port number mapped to the IP address of the destination server in the mapping table, the UDP relay may subsequently identify the IP address of the destination server as 192.168.58.21.

The UDP relay may subsequently convert the message to a modified message and replace a destination IP address in the header of the message with the IP address of the destination server. Further, the UDP relay modifies destination and source Media Access Control

(MAC) address of the message. In one implementation, the UDP relay is configured to change the destination MAC address to a MAC address of a next hop router. The UDP relay, in one implementation, may ascertain the MAC address of the next hop router based on a table corresponding to an address resolution protocol (ARP). Further, the UDP relay changes the source MAC address to a router MAC address of the UDP relay. The UDP relay subsequently determines a time to live (TTL) value of the message and decrements the value by one in case the TTL value of the message is greater than one. In case, the TTL value of the message is less than one, the UDP relay discards the message. The modified message thus obtained is transferred to the next hop router that further forwards the modified message to the destination server based on the IP address provided in the modified message.

The destination server, on receiving the modified message, processes the same and responds to the communication device to initiate the communication based on a source IP address included in the modified message. The present subject matter thus describes methods and systems for relaying message based on IP address, thereby reducing the number of messages in the communication network. As a result, congestion in intermediate networks and the destination network is averted. Subsequently, the operation cost is also reduced as multiple UDP relays are not utilized and less number of network resources are used for relaying messages in the communication network.

The described methodologies can be implemented in hardware, firmware, software, or a combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof. Herein, the term “system” encompasses logic implemented by software, hardware, firmware, or a combination thereof.

For a firmware and/or software implementation, the methodologies can be implemented with modules (e.g., procedures, functions, and so on) that perform the functions described herein. Any machine readable medium tangibly embodying instructions can be used in implementing the methodologies described herein. For example, software codes and programs can be stored in a memory and executed by a processing unit. Memory can be implemented within the processing unit or may be external to the processing unit. As used herein the term “memory” refers to any type of long term, short term, volatile, nonvolatile, or other storage devices and is not to be limited to any particular type of memory or number of memories, or type of media upon which memory is stored.

In another firmware and/or software implementation, the functions may be stored as one or more instructions or code on a computer-readable medium. Examples include computer-readable media encoded with a data structure, and the computer-readable media encoded with a computer program. The computer-readable media may take the form of an article of manufacturer. The computer-readable media includes physical computer storage media. A storage medium may be any available medium that can be accessed by a computer. By way of example, and not limitation, such a computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of the computer-readable media.

It should be noted that the description and figures merely illustrate the principles of the present subject matter. It will thus be appreciated that those skilled in the art will be able to devise various arrangements that, although not explicitly described or shown herein, embody the principles of the present subject matter and are included within its spirit and scope. Further, all examples recited herein are principally intended expressly to be only for pedagogical purposes to aid the reader in understanding the principles of the present subject matter and the concepts contributed by the inventor(s) to furthering the art, and are to be construed as being without limitation to such specifically recited examples and conditions. Moreover, all statements herein reciting principles, aspects, and embodiments of the present subject matter, as well as specific examples thereof, are intended to encompass equivalents thereof.

It will also be appreciated by those skilled in the art that the words during, while, and when as used herein are not exact terms that mean an action takes place instantly upon an initiating action but that there may be some small but reasonable delay, such as a propagation delay, between the initial action and the reaction that is initiated by the initial action. Additionally, the word “connected” and “coupled” is used throughout for clarity of the description and can include either a direct connection or an indirect connection.

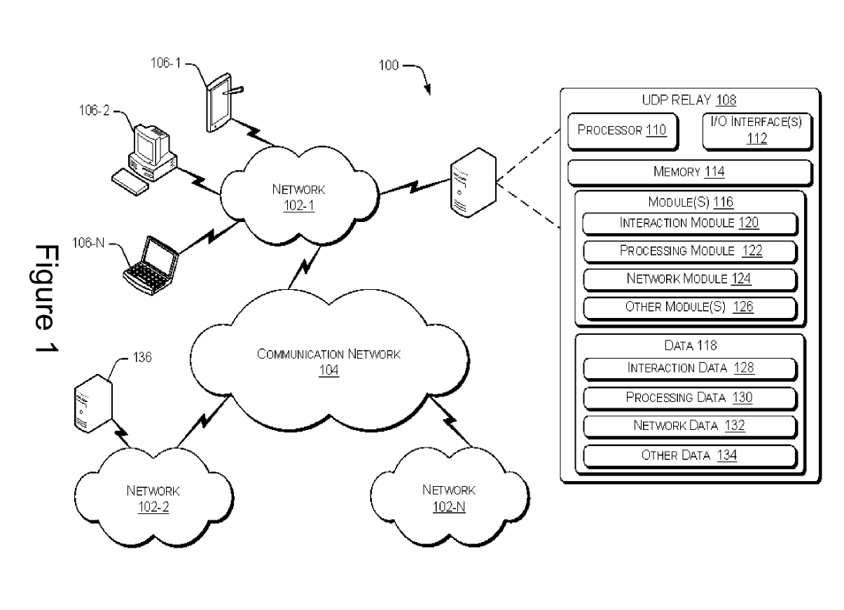

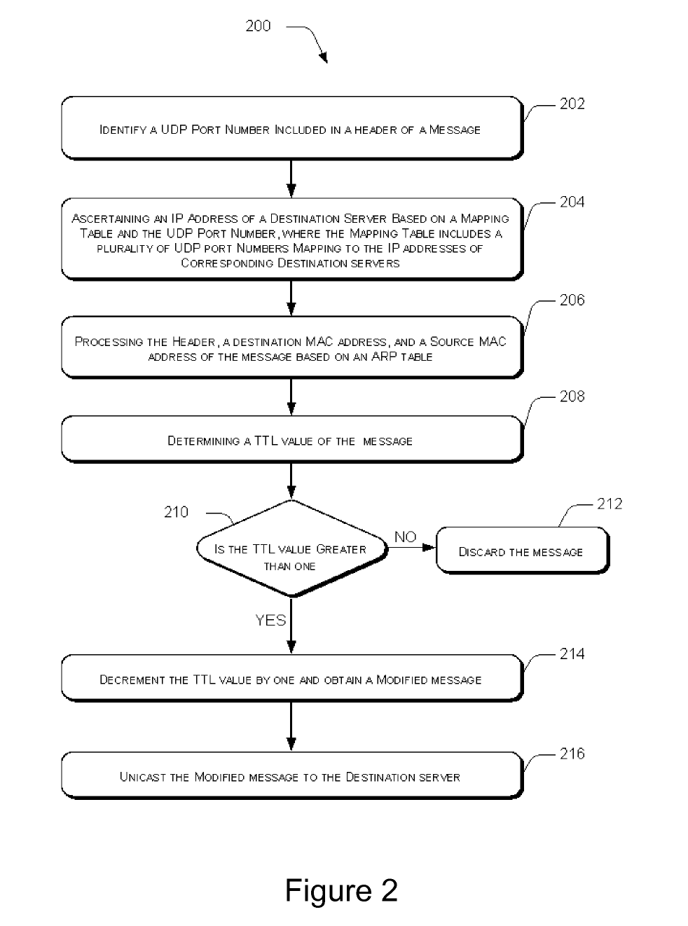

The manner in which the systems and the methods of IP address based UDP relay in communication networks shall be implemented has been explained in details with respect to the FIG. 1 and FIG. 2. While aspects of described systems and methods of IP address based UDP relay in communication networks can be implemented in any number of different computing systems, transmission environments, and/or configurations, the embodiments are described in the context of the following exemplary system(s).

FIG. 1 illustrates a network environment 100 for IP addressed based UDP relay. The network environment 100 includes one or more networks 102-1, 102-2, . . . , and 102-N, hereinafter collectively referred to as networks 102 and individually referred to as the network 102, connected to a communication network 104, according to an embodiment of the present subject matter. According to an example, the networks 102 and the communication network 104 can be implemented as one of the different types of networks, such as intranet, local area network (LAN), virtual LAN (VLAN), wide area network (WAN), and the internet. The network 102 may be IP based. The network 102 may either be a dedicated network or a shared network, which represents an association of the different types of networks that use a variety of protocols, for example, Hypertext Transfer Protocol (HTTP), Transmission Control Protocol/Internet Protocol (TCP/IP), User Datagram Protocol (UDP), and Wireless Application Protocol (WAP) to communicate with each other. Further, the network 102 may include a variety of network devices, including routers, bridges, servers, computing devices, and storage devices.

The communication network 104 may be a wireless network, or a combination of wired and wireless network. The communication network 104 can be a collection of individual networks, interconnected with each other and functioning as a single large network (e.g., the internet or an intranet). Examples of such individual networks include, but are not limited to, 3rd Generation Partnership Project (3GPP), Long Term Evolution (LTE), and the like. Further, depending on the technology, the communication network 104 includes various network entities, such as gateways, routers; however, such details have been omitted for ease of understanding.

Further, the networks 102 include one or more communication devices 106-1, 106-2, 106-3, . . . , and 106-N, hereinafter collectively referred to as communication devices 106 and individually referred to as the communication device 106, connected to one or more networks 102, according to an embodiment of the present subject matter.

The communication devices 106 may be defined as User Equipments (UEs) used by users to communicate with each other. Examples of the communication devices 106 may include, without limitation, mobile phones, landline phones, desktop computers, hand-held devices, laptops or other portable computers, network computers, and the like. Each of the communication devices 106 work on a communication protocol as defined by the network to which the communication device 106 is coupled.

Further, the network 102 includes a UDP relay 108 configured to handle broadcast data packets transmitted to any of the communication devices 106, servers, ports, and the like, in any of the networks 102. In one implementation, the UDP relay 108 is configured to relay data packets, hereinafter referred to as message, originating in a home network, say a network 102-1 to which the UDP relay 108 is connected, to a destination server of a destination network, say a network 102-2, in which the message is to be transmitted.

For the purpose, the UDP relay 108 includes one or more processor(s) 110, I/O interface(s) 112, and a memory 114 coupled to the processor 110. The processor(s) 110 may be implemented as one or more microprocessors, microcomputers, microcontrollers, digital signal processors, central processing units, state machines, logic circuitries, and/or any devices that manipulate signals based on operational instructions. Among other capabilities, the processor(s) 110 are configured to fetch and execute computer-readable instructions stored in the memory 114.

The functions of the various elements shown in the figures, including any functional blocks labeled as “processor(s)”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included.

The I/O interface(s) 112 may include a variety of software and hardware interfaces, for example, interfaces for peripheral device(s), such as data input output devices, referred to as I/O devices, storage devices, network devices, etc. The I/O device(s) may include Universal Serial Bus (USB) ports, Ethernet ports, host bus adaptors, etc., and their corresponding device drivers. The I/O interface(s) 112 facilitate the communication of the UDP relay 108 with various networks, such as the communication network 104, the networks 102 and various communication and computing devices, such as the communication devices 106.

The memory 114 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

The UDP relay 108 may also include various modules 116. The modules 116, amongst other things, include routines, programs, objects, components, data structures, etc., which perform particular tasks or implement particular abstract data types. The modules 116 may also be implemented as, signal processor(s), state machine(s), logic circuitries, and/or any other device or component that manipulate signals based on operational instructions.

Further, the modules 116 can be implemented in hardware, instructions executed by a processing unit, or by a combination thereof. The processing unit can comprise a computer, a processor, such as the processor 110, a state machine, a logic array or any other suitable devices capable of processing instructions. The processing unit can be a general-purpose processor which executes instructions to cause the general-purpose processor to perform the required tasks or, the processing unit can be dedicated to perform the required functions.

In another aspect of the present subject matter, the modules 116 may be machine-readable instructions (software) which, when executed by a processor/processing unit, perform any of the described functionalities. The machine-readable instructions may be stored on an electronic memory device, hard disk, optical disk or other machine-readable storage medium or non-transitory medium. In one implementation, the machine-readable instructions can be also be downloaded to the storage medium via a network connection.

The UDP relay 108 may further include data 118, which amongst other things, serves as a repository for storing data processed, received, associated, and generated by one or more of the module(s) 116.

The module(s) 116 further include an interaction module 120, a processing module 122, a network module 124, and other module(s) 126. The other module(s) 126 may include programs or coded instructions that supplement applications and functions of the UDP relay 108.

The data 118 includes, for example, interaction data 128, processing data 130, network data 132, and other data 134. The other data 134 includes data generated as a result of the execution of one or more modules in the other module(s) 126.

In an embodiment of the present subject matter, the network 102-1 is hereinafter referred to as VLAN1 and a destination network, say the network 102-2 is hereinafter referred to as VLAN2. Although, the description herein is with reference to a VLAN, however, the present subject matter may be applicable in all communication networks supporting UDP protocol, albeit with a few modifications, as would be understood by a person skilled in the art.

In an internet protocol (IP) based communication network environment, data communication between any of the several individual networks connected through the communication network environment is based on user datagram protocol (UDP). For the purpose, a UDP relay, such as the UDP relay 108 is present in each of the individual networks for handling data communication between the networks.

According to an implementation of the present subject matter, the UDP relay 108 is configured to process a message, transmitted to a destination server, such as the UDP server 136, of a destination network, such as the VLAN2, broadcasted by the communication device 106-1. In said implementation, the interaction module 120 is configured to receive the message broadcasted by the communication device 106-1. In one implementation, the message includes a UDP port number in a header of the message. The UDP port number is mapped to an IP address of a destination server in a mapping table. In one implementation, a network administrator may configure the IP address of the destination server and map it to the UDP port number in the mapping table. The mapping table includes a list of UDP ports mapping to the IP addresses of the corresponding servers. For example, the communication device 106-1 intending to transmit a message to a destination server with IP address 192.168.58.21 and UDP port number as 5001 may add the UDP port number, i.e., 5001 in a header of the message and broadcast the message in its home network.

In one implementation, the processing module 122 is configured to process the message and ascertain the IP address mapped to the UDP port number included in the header of the message. For the purpose, the processing module 122 includes a mapping table comprising UDP port numbers mapped to the IP addresses of the destination servers. Based on the mapping table, the processing module 122 ascertains the IP address mapped to the UDP port number specified in the header of the message. Subsequently, the processing module 122 includes the IP address of the destination server in a destination IP address field in the header of the message. For instance, as described in the previous example, the processing module 122 processes the message and ascertains the UDP port number as 5001. Based on the UDP port number, the processing module 122 may subsequently identify the IP address of the destination server as 192.168.58.21 based on a mapping table.

Further, in one implementation, the processing module 122 is configured to modify a destination media access control (MAC) address and a source MAC address of the message. In one implementation, the processing module 122 changes the destination MAC address of the message to a MAC address of a next hop router. The processing module 122 may ascertain the MAC address of the next hop router according to an address resolution protocol (ARP) table based on the ARP, as would be understood by a person skilled in the art. In one implementation, the processing module 122 may obtain the mapping table and the ARP table from the processing data 130. Subsequently, the processing module 122 changes the source MAC address of the message to a router MAC address of the UDP relay 108. However, the processing module 122, in one implementation, may not modify a source IP address corresponding to the communication device 106-1 included in the message. In order to establish communication with the communication device 106-1, the destination server can directly communicate with the communication device 106-1 as the source IP address of the message is not modified.

Subsequently, the processing module 122 determines a time to live (TTL) value included in the message. In one implementation, if the TTL value of the message is determined as greater than one, the processing module 122 is configured to decrement the TTL value of the message by one and obtain a modified message. In another implementation, if the TTL value of the message is determined less than one, the processing module 122 is configured to discard the message.

In one implementation, the network module 124 is configured to relay the modified broadcast message as unicast message to the UDP server 136, based on IP address. In one implementation, if the destination server is unknown, the network module 124 is configured to interact with the next hop router. Subsequently, the next hop router, then, unicasts the modified message to the destination server based on the IP address, corresponding to the UDP port, specified in the mapping table.

UDP relay of messages based on IP address in communication networks help in reducing the number of messages in the communication network thereby avoiding clustering of messages and reducing occurrences of congestion in the communication network. Further, the operations cost is reduced as less number of UDP relays are deployed for relaying messages in the communication network.

FIG. 2 illustrates a method 200 for IP addressed based UDP relay in a communication network, according to an embodiment of the present subject matter. The order in which the method 200 is described is not intended to be construed as a limitation, and any number of the described method blocks can be combined in any order to implement the method 200, or any alternative methods. Additionally, individual blocks may be deleted from the method without departing from the spirit and scope of the subject matter described herein. Furthermore, the method can be implemented in any suitable hardware, software, firmware, or combination thereof.

The method may be described in the general context of computer executable instructions. Generally, computer executable instructions can include routines, programs, objects, components, data structures, procedures, modules, functions, etc., that perform particular functions or implement particular abstract data types. The method may also be practiced in a distributed computing environment where functions are performed by remote processing devices that are linked through a communications network. In a distributed computing environment, computer executable instructions may be located in both local and remote computer storage media, including memory storage devices.

A person skilled in the art will readily recognize that steps of the method can be performed by programmed computers. Herein, some embodiments are also intended to cover program storage devices, for example, digital data storage media, which are machine or computer readable and encode machine-executable or computer-executable programs of instructions, where said instructions perform some or all of the steps of the described method. The program storage devices may be, for example, digital memories, magnetic storage media, such as a magnetic disks and magnetic tapes, hard drives, or optically readable digital data storage media. The embodiments are also intended to cover both communication network and communication devices configured to perform said steps of the exemplary methods.

At block 202, a UDP port number included in a header of a message is identified. In one implementation, a processing module of a UDP relay, such as the processing module 122, is configured to identify the UDP port number included in the header of the message.

At block 204, an IP address of a destination server is ascertained based on a mapping table. In one example, the processing module 122 ascertains the IP address based on a mapping table. In one implementation, the mapping table includes a plurality of UDP port numbers mapped to the IP addresses of the corresponding destination servers. In one implementation, a user, for example, a network administrator may configure the UDP port numbers and map them to the IP addresses of the corresponding destination server in the UDP relay. In one implementation, the UDP port number is mapped to an IP address of a destination server. For example, the header of the message may include a UDP port number 5001 which is mapped to an IP address 192.168.11.21 of the destination sever.

At block 206, the header, a destination MAC address, and a source MAC address of the message are modified. In one implementation, the processing module is configured to process the header of the message. The processing module 122, upon ascertaining the IP address of the destination server, includes the IP address in a destination IP address field of the header of the message. In another implementation, the processing module is configured to modify the destination MAC address and a source MAC address of the message. In one implementation, the processing module changes the destination MAC address of the message to a MAC address of a next hop router. In the said implementation, the processing module may ascertain the MAC address of the next hop router based on an address resolution protocol (ARP) table based on ARP, as would be understood by a person skilled in the art. Subsequently, the processing module changes the source MAC address of the message to a router MAC address of the UDP relay.

At block 208, a time to live (TTL) value of the message is determined. In one implementation, the processing module 122 is configured to determine the TTL value of the message using conventional methods, as will be understood by a person skilled in the art.

At block 210, a comparison is made between the TTL value of the message and a default value. In one implementation, the comparison of the TTL value of the message is made with one. If it is determined that the TTL value of the message is less than one, which is the ‘NO’ path, the method proceeds towards block 212. At block 212, the processing module 122 is configured to discard the message.

If determined otherwise, i.e., if the TTL value is determined to be greater than one, which is the ‘YES’ path, the method proceeds towards block 214. At block 214, the processing module 122 is configured to decrement the TTL value of the message by one and obtain a modified message.

At block 216, the modified message is unicasted. In one implementation, a network module, such as the network module 124, is configured to unicast the modified message to the IP address included in the destination IP address of the modified message. In one implementation, the IP address corresponds to the destination server of a destination network of a UDP port.

Although embodiments for methods and systems for IP addressed based UDP relay in a communication network have been described in a language specific to structural features and/or methods, it is to be understood that the invention is not necessarily limited to the specific features or methods described. Rather, the specific features and methods are disclosed as exemplary embodiments for IP addressed based UDP relay in a communication network.

1. A method for User datagram protocol (UDP) relay in communication networks, the method comprising:
identifying a UDP port number included in a header of a message from a communication device;
ascertaining an internet protocol (IP) address of a destination server based on a mapping table and the UDP port number, wherein the mapping table includes a list of plurality of UDP port numbers mapping to the IP addresses of corresponding destination servers;
modifying the message to obtain a modified message based at least on the IP address; and
unicasting the modified message to the destination server.

2. The method as claimed in claim 1, wherein the modifying comprises:
processing the header of the message to include the IP address of the destination server in a destination IP address field of the message;
replacing a destination media access control (MAC) address of the message by a MAC address of a next hop router; and
replacing a source MAC address of the message by a router MAC address of a UDP relay, wherein the UDP relay is in a home network of the message.

3. The method as claimed in claim 1, wherein the modifying further comprises determining a TTL value of the message and reducing the TTL value of the message by one for the TTL value message being greater than one.

4. The method as claimed in claim 3, wherein the determining further comprises discarding the message for the TTL value of the message being less than one.

5. The method as claimed in claim 1, wherein the message further includes a source IP address, and wherein the source IP address contains an IP address of the communication device.

6. A UDP relay comprising:
a processor; and
a processing module, coupled to the processor, the processing module configured to:
identify a UDP port number included in a header of a message from a communication device;
ascertain an internet protocol (IP) address of a destination server based on a mapping table and the UDP port number, wherein the mapping table includes a list of plurality of UDP port numbers mapping to the IP addresses of corresponding destination servers; and
modify the message to obtain a modified message based at least on the IP address; and
a network module, coupled to the processor, the network module configured to unicast the modified message to the destination server.

7. The UDP relay as claimed in claim 6, wherein the processing module is further configured to:
process the header of the message to include the IP address of the destination server;
replace a destination MAC address of the message to a MAC address of a next hop router;
replace a source MAC address of the message to a router MAC address of a UDP relay, wherein the UDP relay is in a home network of the message; and
determine a TTL value of the message and reduce the TTL value of the message by one for the TTL value of the message being greater than one.

8. The UDP relay as claimed in claim 6, wherein the processing module is further configured to discard the message for the TTL value of the message being less than one.

9. The UDP relay as claimed in claim 6 further comprising an interaction module, coupled to the processor, wherein the interaction module is configured to receive a message from the communication device.

10. A computer-readable medium having embodied thereon a computer program for executing a method for IP addressed based UDP relay in communication networks, the method comprising:
identifying a UDP port number included in a header of a message from a communication device;
ascertaining an internet protocol (IP) address of a destination server based on a mapping table and the UDP port number, wherein the mapping table includes a list of plurality of UDP port numbers mapping to the IP addresses of corresponding destination servers;
modifying the message to obtain a modified message based at least on the IP address; and
unicasting the modified message to the destination server.
